(19) United States
(12) Patent Application Publication
(10) Pub. No.: US 2022/0000153 A1
(43) Pub. Date: Jan. 6, 2022

(54) METHOD AND SYSTEM FOR PROCESSING A MATERIAL BY PRESSURE WAVE

(71) Applicant: Strauss Group Ltd., Petach-Tikva (IL)

(72) Inventor: Zamir TRIBELSKY, Beit-Shemesh (IL)

(73) Assignee: Strauss Group Ltd., Petach-Tikva (IL)

(21) Appl. No.: 17/291,321

(22) PCT Filed: Nov. 5, 2019
(86) PCT No.: PCT/IL2019/051209

§ 371 Date: May 5, 2021

Related U.S. Application Data
(60) Provisional application No. 62/755,622, filed on Nov. 5, 2018.

(51) Int. Cl. A23L 5/30; B01J 19/10; A23L 3/30; A23F 5/16; B24B 1/04

(52) U.S. Cl. CPC A23L 5/32; B01J 19/10; A23L 3/30; B06B 1/04; B24B 1/04; A23V 2002/00; A23F 5/16

(57) ABSTRACT

A system for processing a material comprises a reactor having an inlet for receiving a flow of the material and an outlet for releasing processed material from the reactor; an acoustic transducer for producing soundwaves propagating within the reactor and through the material; and one or more strings, placed under tension within the reactor and selected to resonantly vibrate at a predetermined frequency, responsively to the soundwave.

### RELATED APPLICATION

This application claims the benefit of priority of U.S. Provisional Patent Application No. 62/755,622 filed Nov. 5, 2018, the contents of which are incorporated herein by reference in their entirety.

### FIELD AND BACKGROUND OF THE INVENTION

The present invention, in some embodiments thereof, relates to material processing, and, more particularly, but not exclusively, to a method and system for processing a material, such as, but not limited to, food, by pressure wave.

Plants and natural products are the source of a significant array of compounds, typically bioactive compounds, useful in numerous fields including, but not limited to, foods, functional foods, nutraceuticals, pharmaceuticals, and cosmetics. Because these useful compounds are present in the natural material in relatively low concentrations, the extraction of these commercially attractive natural ingredients is the focus of much industrial attention. Many techniques have been employed for extraction, including steam distillation, solvent extraction, and supercritical fluid extraction by high pressure carbon dioxide, and microwave-assisted extraction.

Also known are techniques that employ ultrasound waves for processing food. For example, U.S. Published Application No. 20080032030 discloses the use of ultrasound for producing beverages from coffee beans that have been exposed to water.

U.S. Published Application No. 20120135115 discloses a method for preparation of hard foods for consumption by a transmission of cavitating ultrasonic waves to hard food soaked in water.

International Publication No. WO2017/064696, the contents of which are hereby incorporated by reference, discloses a method for processing a material, by propelling a bulk of material throughout an artificially generated storm, and rotationally impelling the bulk of material, to generate acoustic effects operative for processing of the material. The acoustic effects comprise pressure gradients acoustically coupled to, and resonating with, the material.

### SUMMARY OF THE INVENTION

The inventor found that ultrasound extraction systems create heat and byproducts, and destroy delicate ingredients by forming free radical species. The inventor found that ultrasound extraction systems are monophonic, are very limited in creating resonances, and have low efficacies.

Thus, according to an aspect of some embodiments of the present invention there is provided a system for processing a material. The system comprises: a reactor having an inlet for receiving a flow of the material and an outlet for releasing processed material from the reactor; a first acoustic transducer and a second acoustic transducer, acoustically coupled from two opposite ends to the reactor for producing soundwaves propagating within the reactor and through the material in opposite directions; and a set of strings, placed under tension within the reactor and selected to resonantly vibrate at a predetermined frequency, responsively to the soundwaves.

According to some embodiments of the invention the set of strings are arranged conically to receive soundwaves from the first transducer at an apex of the conical arrangement.

According to some embodiments of the invention set of strings are arranged to form a flat shape.

According to some embodiments of the invention the set of strings are arranged to form a shape selected from the group consisting of a parabolic shape, an elliptical shape, a round shape, a triangular shape, and a circular shape.

According to some embodiments of the invention the at least one of the first and the second transducers is an electromagnetic transducer.

According to some embodiments of the invention each of the first and the second transducers is an electromagnetic transducer.

According to some embodiments of the invention the first transducer is coupled to the reactor by an acoustic horn placed inside the reactor.

According to some embodiments of the invention the acoustic horn is in direct contact with the material.

According to some embodiments of the invention the second transducer is coupled to the reactor by an acoustic waveguide.

According to some embodiments of the invention the system comprises an acoustic membrane positioned between the waveguide and the resonator.

According to some embodiments of the invention the acoustic membrane is coupled directly to the set of strings.

According to some embodiments of the invention the system comprises an acoustic refracting element for refracting a soundwave produced by the first transducer before the soundwave arrives at the set of strings.

According to some embodiments of the invention at least a portion of the reactor comprises a cooling passage at a wall of the reactor.

According to some embodiments of the invention the system comprises a control system having a circuit configured for driving the transducers to produce the soundwaves at the predetermined frequency.

According to some embodiments of the invention the circuit of the control system is configured to drive the transducers to operate in phase.

According to some embodiments of the invention the circuit of the control system is configured to drive the transducers to operate out of phase.

According to some embodiments of the invention the circuit of the control system is configured to drive the transducers such that the soundwaves are in phase.

According to some embodiments of the invention the circuit of the control system is configured to drive the transducers such that the soundwaves are in opposite phases.

According to some embodiments of the invention the circuit comprises at least one circuitry selected from the group in analog circuitry, digital circuitry, hybrid circuitry, sound additive circuitry, sound subtractive circuitry, FM circuitry, pulse control modulation (PCM) circuitry, physical modeling circuitry, morphing circuitry, and sampling circuitry.

According to some embodiments of the invention the control system is configured to reverse a direction of the flow by forcing material to enter the reactor through the outlet and exit through the inlet.

According to an aspect of some embodiments of the present invention there is provided a system for processing a material. The system comprises: a reactor having an inlet for receiving a flow of the material and an outlet for releasing processed material from the reactor; an acoustic transducer for producing soundwaves propagating within the reactor and through the material; and at least one string, placed under tension within the reactor and selected to resonantly vibrate at a predetermined frequency, responsively to the soundwave.

According to some embodiments of the invention the system wherein the reactor is a conduit.

According to some embodiments of the invention the system wherein the reactor is a chamber.

According to some embodiments of the invention the system comprises an acoustic component selected from the group consisting of an acoustic reflector, an acoustic deflector, a refractive acoustic element, an acoustic stirrer, an acoustic lens, and acoustic concentrator, a compound concentrator, a compound parabolic concentrator, an acoustic absorber, and an acoustic waveguide.

According to some embodiments of the invention the at least one string is a set of strings arranged conically to receive soundwaves from the first transducer at an apex of the conical arrangement.

According to some embodiments of the invention the transducer is coupled to the reactor by an acoustic horn placed inside the reactor.

According to some embodiments of the invention the acoustic horn is in direct contact with the material.

According to some embodiments of the invention the transducer is coupled to the reactor by an acoustic waveguide.

According to some embodiments of the invention the system according to claim

According to some embodiments of the invention their comprising an acoustic membrane positioned between the waveguide and the resonator.

According to some embodiments of the invention the acoustic membrane is coupled directly to the string.

According to some embodiments of the invention the system comprises an acoustic refracting element for refracting a soundwave produced by the first transducer before the soundwave arrives at the set of strings.

According to some embodiments of the invention at least a portion of the reactor comprises a cooling passage at a wall of the reactor.

According to some embodiments of the invention the reactor is double-walled and the cooling passage is between an inner wall and an outer wall of the double wall.

According to some embodiments of the invention the system comprises a control system having a circuit configured for driving the transducer to produce the soundwave at the predetermined frequency.

According to some embodiments of the invention the circuit of the control system is configured to provide to the transducers a signal having a waveform selected from the group consisting of a sawtooth waveform, a triangular waveform, a square wave waveform, a sinusoidal waveform, a waveform composed of a combination of wavelets, and any combination thereof.

According to some embodiments of the invention the control system is configured to reverse a direction of the flow by forcing material to enter the reactor through the outlet and exit through the inlet.

According to an aspect of some embodiments of the present invention there is provided a method of processing a material. The method comprises supplying a flow of the material to a reactor having an inlet for receiving the flow and an outlet for releasing processed material from the reactor; and generating soundwaves to propagate within the reactor and through the material in opposite directions, and to resonantly vibrate a set of strings placed under tension within the reactor.

According to some embodiments of the invention the method further comprising cooling or heating the material prior to the supplying.

According to some embodiments of the invention the set of strings are arranged conically to receive soundwaves at an apex of the conical arrangement.

According to some embodiments of the invention the method comprises coupling one of the soundwaves to the reactor by an acoustic horn placed inside the reactor.

According to some embodiments of the invention the method comprises coupling one of the soundwaves to the reactor by an acoustic waveguide.

According to some embodiments of the invention the method comprises refracting one of the soundwaves before the soundwave arrives at the set of strings.

According to some embodiments of the invention the method comprises cooling the reactor.

According to some embodiments of the invention the generating the soundwaves comprises transmitting to the transducers a signal having a waveform selected from the group consisting of a sawtooth waveform, a triangular waveform, a square wave waveform, a sinusoidal waveform, a waveform composed of a combination of wavelets, and any combination thereof.

According to some embodiments of the invention the generating the soundwaves comprises driving two sound transducers to operate in phase.

According to some embodiments of the invention the generating the soundwaves comprises driving two sound transducers to operate in opposite phases.

According to some embodiments of the invention the generating the soundwaves comprises driving two sound transducers such that the soundwaves are in phase.

According to some embodiments of the invention the generating the soundwaves comprises driving two sound transducers such that the soundwaves are in opposite phases.

According to some embodiments of the invention the method comprises reversing a direction of the flow in the reactor.

According to some embodiments of the invention the material is edible.

According to some embodiments of the invention the material is a medicine.

According to some embodiments of the invention the material is a cosmetic product.

According to some embodiments of the invention the material comprises at least one type of material selected from the group consisting of: coffee beans, coffee extract, ground coffee beans, soy beans, soy extract, ground soy beans, coconut beans, coconut extract, ground coconut beans, olives, mashed olives, sugar, sucrose, sugar substitute, salt, aloe vera, aloe vera extract, echinacea, echinacea extract, algae, a fruit, and water-oil emulsion.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGs. 1A-C are schematic illustrations of a system for processing a material, according to some embodiments of the present invention;

FIG. 2 is a flowchart diagram of a method suitable for processing a material according to some embodiments of the present invention; and

FIG. 3 is a block diagram of an experimental setup, used in experiments performed according to some embodiments of the present invention;

FIGS. 4A-D are schematic illustrations of the system in embodiments of the invention in which the system comprises more than one reactor; and

FIGS. 5A-F are schematic illustrations of a set of strings, which can be used in the system according to some embodiments of the present invention.

### DESCRIPTION OF SPECIFIC EMBODIMENTS OF THE INVENTION

The present invention, in some embodiments thereof, relates to material processing, and, more particularly, but not exclusively, to a method and system for processing a material, such as, but not limited to, food, by pressure wave.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present embodiments harness soundwaves for the purpose of processing a material. The Inventor found that soundwaves can effect a multiplicity of phenomena, including, without limitation, extraction, grinding and sterilization. The behavioral patterns of soundwaves obey the laws of reflections, refraction and diffraction, just like light.

The Inventor successfully devised a method and a system for harnessing soundwave energy for processing a material. The Inventor found that it is particularly advantageous to tune the frequencies, and optionally and preferably other parameters, such as intensity, relative phase, and envelope, of the soundwaves, according to the material to be processed, since such tuning significantly improves the efficiency of the processing. The inventor found that the soundwave can serve as a driving force that, when applied at or close to a specific frequency, can induce a resonance and promote the expansion and hydration of dry materials, as well as promote a mass transfer process. For example, a resonance can form cracks in walls of beans thereby promoting mass transfer out of the beans. Resonance can also dissociate particles to their constituents or break large particles into smaller particles. Such a reduction in the size of the particle increases the contact area between the particles and their surrounding medium (e.g., carrier liquid), and thus facilitates mass transfer of a target substance from the particles to the medium.

The inventor found that the heat produced by the interaction between the soundwave and the material can sterilize the material, and that generation of heat by soundwave can be improved by operating at or close to a specific resonance frequency.

The method and system of the present embodiments can thus be used for processing a material, in particular for producing an extract of a raw material, for grinding a material and/or for sterilizing a material. The method and a system of the present embodiments can additionally or alternatively effect at least one of: drying, sculpturing, shearing, tearing, texturing, dissociating, disintegration, coalescing, sorting, morphing, binding, crushing, particle size reduction, particle size increase, agglomeration, atomizing, fogging, acoustic-atomizing, powdering, homogenizing, separating, atomization, liquefaction, crushing, drying, physical interaction, temperature variation, and/or any combination thereof.

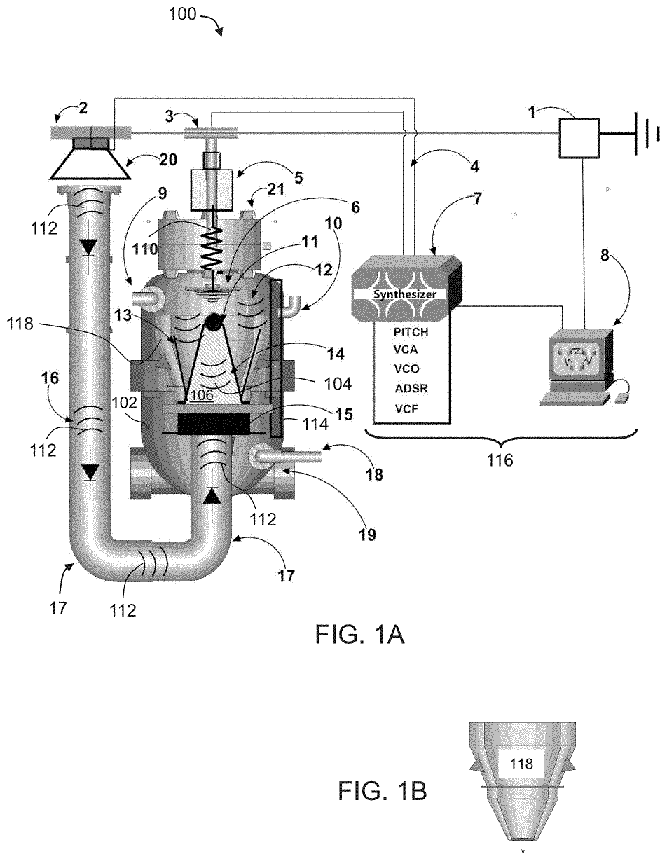

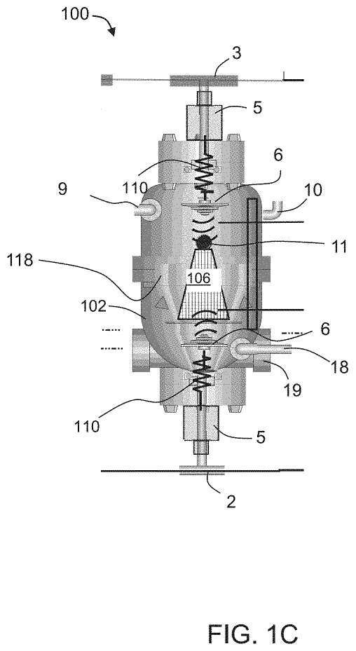

Referring now to the drawings, FIG. 1A illustrates a system 100 for processing a material, according to some embodiments of the present invention. Preferably, the material is raw material, but the present embodiments also contemplated processing a partially processed material. For example, when the raw material is in the form of beans, system 100 can receive the beans and process them, or it can receive ground beans, or an extract from the beans in which case system 100 can process the ground beans or the extract.

System 100 can be used for processing many types of materials, such as, but not limited to, edible materials, medicines, and cosmetic products. More specific examples of types of materials that can be processed by system 100, include, without limitation, coffee beans, coffee extract, ground coffee beans, soy beans, soy extract, ground soy beans, coconut beans, coconut extract, ground coconut beans, olives, mashed olives, sugar, sucrose, sugar substitute, salt, aloe vera, aloe vera extract, echinacea, echinacea extract, algae, a fruit, water-oil emulsion, and any combination or sub-combination thereof.

System 100 optionally and preferably comprises a reactor 102 having a first port 9 and a second port outlet 18. Typically, first port 9 is used as an inlet for receiving a flow of the material, and port 18 is used as an outlet for releasing processed material from reactor 102. The flow is preferably a flow of a mixture of the material and a carrier liquid (e.g., water). When the material is in itself in liquid form (e.g., when the material is an extract), the flow can include the material without a carrier liquid. Typically, however, the material is mixed with a carrier liquid even the material is in liquid form.

While ports 9 and 18 above are referred to above as “inlet” and “outlet”, system 100 may in some embodiments of the present invention have an operation mode in which port 18 serves as the inlet and port 9 serves as the outlet, so that the material is fed into port 18 and is released through port 9. In some embodiments of the present invention, system 100 switches, for example, periodically or upon user intervention, between a first operation mode in which port 9 serves as the inlet and port 18 serves as the outlet, and a second operation mode in which port 18 serves as the inlet and port 9 serves as the outlet, thus effecting a reverse flow in reactor 102. The advantage of reversing the direction of the flow is that a reverse flow can create a high hydraulic pressure, which increases the speed of sound in the material, and can also reduce the likelihood or prevent sedimentation of solids and clogging.

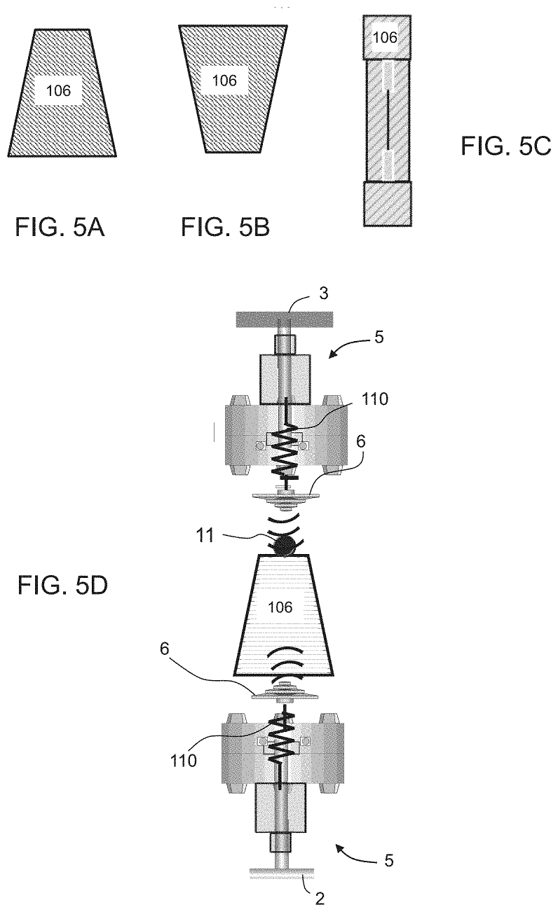

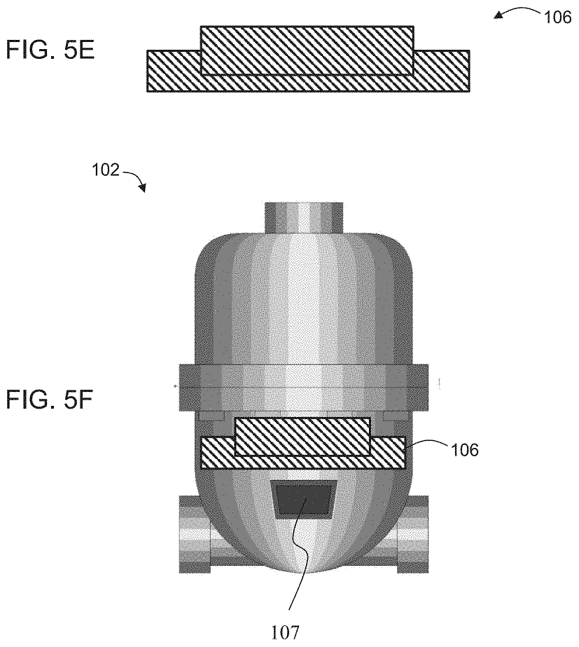

Reactor 102 is preferably made of a metal, such as, but not limited to, titanium, stainless steel, aluminum, copper and any combination thereof. Preferably, but not necessarily, reactor 102 is made of a material that is a food grade material and/or biocompatible material. Reactor 102 can have any shape. Typically, but not necessarily, reactor 102 has a generally parabolic shape to allow the reactor to serve as a parabolic concentrator. A typical geometrical concentration ratio of the reactor is from about 2:1, to about 5:1. Preferably, reactor 102 has a tapered shape or includes a tapered section 118, e.g., the shape of a cone, a frustum or the like. The generatrix of the tapered section is generally shown at 13. Tapered section 118, is better illustrated in FIG. 1B. The advantage of having a tapered shape is that it allows the reactor to serve as an acoustic concentrator. In some embodiments of the present invention reactor comprises an inspection window (shown at 107 in FIG. 5) to allow the operator to inspect the interior of the reactor.

Reactor 102 can be a conduit, a chamber, a pipe, and/or a cylindrical processing enclosure. Reactor 102 can have at least one inlet and outlet and may optionally and preferably have any number of accommodating inserts, such as, but not limited to, acoustic string sets, filters, sound deflectors, reflecting surfaces and vibration isolation zones. In some embodiments of the present invention reactor 102 has dimensions selected for acting as a resonator for specific wavelength and frequencies. Optionally and preferably reactor 102 has one or more sound reflectors, deflectors, concentrators, compounded concentrators, parabolic sections, wave dumping sections, and sections for increasing or decreasing acoustic impedance matching. Reactor 102 can also be arranged such that one or more transducers can be coupled into the reactor (or more than one reactor, if present). When more than one reactor are employed, they can be arranged and configured to operate in parallel to allow high throughput processing, or serially to allow more intense processing. Reactor 102 can have a double jacket spacing for cooling. Alternatively or additionally, cooling can be performed by cooling the raw materials to be processed or extracted.

In some embodiments of the present invention system 100 comprises two acoustic transducers 2, 3, acoustically coupled to reactor 102 from two opposite ends thereof, for producing soundwaves 104, 12 propagating within reactor 102 and through the material in opposite (e.g., contrapuntal) directions. Transducers 2 and 3 may have modulated or non-modulated output. Propagation of soundwaves in opposite direction can be ensured in more than one way. In the schematic illustration shown in FIG. 1A, which is not to be considered as limiting, transducer 3 is acoustically coupled to reactor 102 at the top part of reactor 102, and transducer 2 is acoustically coupled to reactor 102 at the bottom part of reactor 102. However, this need not necessarily be the case, since, for some applications, it may be desired to transducer 3 at the bottom part of reactor 102, and transducer 2 at the top part of reactor 102, or to mount reactor 102 horizontally in which case one of transducers 2 and 3 can be coupled at the right hand side of reactor 102, and the other one of transducers 2 and 3 can be coupled at the left hand side of reactor 102.

The inventor found that effecting opposite, or contrapuntal propagation directions for soundwaves 104 and 12 enhances the efficiency of the processing operation via formation of constructive interferences between sound waves in designated zones or areas of the reactor or processing vessel, compared to, for example, configuration in which only one soundwave is generated in the direction of propagation down and/or upstream of the reactor, since the power density in zones at which the wave fronts of the two soundwave collide is sufficiently high to effect size reduction, extraction, homogenization, texturing, grinding and sterilization.

The inventor also found that generating soundwaves 104 and 12 using two transducers that are coupled to opposite sides of reactor 102 is advantageous compared to, for example, a configuration in which one soundwave is generated at one side and is reflected back from the other side or is propagating onward to the other side of the reactor, since the intensity of the reflected soundwave is typically smaller than its intensity once generated.

Another advantage of using contrapuntally coupled transducers is the ability to generate high energy density zones sufficiently strong for producing micro-jet streaming and gradient pressure zone which assist in forming a homogenous distribution of the acoustic energy and hence provide processing uniformity, which often increase the quality of processing.

The generation of contrapuntally coupled sound waves from more than one transducer is optionally and preferably executed by ensuring adequate timing for the soundwave, phase and spatial characteristics, reactor dimensions and processing path-length to prevent, reduce and/or preempt destructive interference and produce constructive interferences.

In some embodiments of the present invention transducer 3 is coupled to reactor 102 by an acoustic horn 6 placed inside reactor 102. Acoustic horn 6 can be a full wavelength or a half wavelength horn, as desired. The main body 5 of transducer 3 is optionally and preferably outside reactor 102, and is connected to horn 6, for example, by means of an elastic rod or spring 110. Transducer 3 is typically an electromechanically transducer. Preferably, transducer 3 can be an electromagnetic transducer, in which case the main body 5 of transducer 3 can include a magnetic field generator and a coil that generate mechanical vibrations in response to an AC signal applied thereto. Alternatively, transducer 3 can be a piezoelectric transducer, in which case the main body 5 of transducer 3 can include a piezoelectric crystal that vibrates in response to an AC signal applied thereto. The advantage of having an electromagnetic transducer is that it can provide larger vibration amplitudes and generates less heat. The advantage of having a piezoelectric transducer is that it is less sensitive to vibrations.

In some embodiments of the present invention system 100 comprises a cooling system (not shown) that circulates a cooling fluid into system 100, as further detailed hereinbelow. These embodiments are particularly useful when piezoelectric transducer is employed, in which case the cooling fluid evacuates heat generated by the transducer.

In some embodiments of the present invention system 100 comprises a motion restriction device, such as, but not limited to, one or more shock absorbers (not shown), that suppress vibration of the reactor 102 during the operation of the transducer(s). These embodiments are particularly useful when an electromagnetic transducer is employed.

When electromagnetic transducer is employed, cooling can be temporarily terminated during the operation of the transducer, since such types of transducers generate less heat. Alternatively, when transducer 3 is an electromagnetic transducer, system 100 can be devoid of a cooling system.

The operation of transducer 3 can be controlled by setting a predetermined power output of the transducer or by setting a predetermined energy output of the transducer. Setting a predetermined energy output of the transducer is preferred from the standpoint of the magnitude of the mechanical moment generated by the transducer and the speed of acceleration.

In some embodiments of the present invention acoustic horn 6 is in direct contact with the material within reactor 102. In these embodiments, transducer 3 is referred to as a “contact transducer.”

In some embodiments of the present invention transducer 2 is coupled to reactor 102 by an acoustic waveguide 16, so that transducer 2 is not in direct contact with the material within reactor 102. In these embodiments, transducer 2 is referred to as a “non-contact transducer.” A soundwave 112 generated by transducer 2 propagates in waveguide 16 and is coupled to reactor 102 at a point of connection between waveguide 16 and reactor 102. Waveguide 16 can be an arched waveguide. In the schematic illustration shown in FIGS. 1A-C, which is not to be considered as limiting, waveguide 16 is U-shaped waveguide having arches shown at 17. However, this need not necessarily be the case, since, for some applications, it may not be necessary for waveguide 16 to be a U-shaped or even an arched waveguide. For example, waveguide 16 can be a straight waveguide 16 in which case transducer 2 is mounted on the side of reactor 102 from which soundwave 112 is to be in-coupled.

Waveguides 16 can be composed of metallic parts, polymeric parts or compounded materials, or combinations. The minimum bend radiuses of waveguide 16 is preferably from about 10 mm to about 30 mm, and its cross-section can be rounded or rectangular or any combinations thereof. The length of waveguide 16 is preferably within tolerances of no more than 1 quarter of the wavelength to soundwave 112 so as to reduce or minimize attenuation, and for preempting back reflection and unwanted absorption.

Transducer 2 may optionally and preferably be in a form of a vibrating diaphragm 20 such as, but not limited to, a diaphragm of a loudspeaker, which can vibrate in response to an AC signal applied thereto. In some embodiments, system 100 comprises an acoustic membrane 15, positioned between waveguide 16 and resonator 102, for enhancing the acoustic coupling between waveguide 16 and reactor 112. Acoustic membrane 15 serves as gateway between the hollow air core waveguide and the liquid. Membrane 15 can be a rigid metallic element, shaped, for example, as a plate. Alternatively or additionally, membrane 15 can include a flexible surface, optionally and preferably flat, in which case it is optionally and preferably characterized by sufficiently high tensile strength. Flexible surfaces suitable for the present embodiments include, without limitation, polymers, plastics, elastomers or compounded materials or any combinations thereof.

It least one of the geometrical characteristics of membrane 15 (size, thickness, depth, width, length, curvature, etc.) is optionally and preferably selected to enhance coupling of the sound waves. Preferably, membrane 15 has impedance selected to promote, amplify, vibrate, transfer and deliver the sound waves onward to the processing area in the reactor whereby the liquid to be processed or extracted, delivers the soundwave by acting as a liquid waveguide. In some embodiments of the present invention membrane 15 has a size that is not smaller than half of the wavelength of the arriving sound waves so as not to limit, distort, diffract or reflect the waves. The thickness of membrane 15 is optionally and preferably sufficiently high to withstand pressure gradient, optionally and preferably without exceeding quarter wavelength of the arriving sound waves for minimizing back reflection.

The present embodiments also contemplate configurations in which both transducers are contact transducers. An exemplary illustration of this embodiment is illustrated in FIG. 1C, showing that both transducers 2 and 3 have main body 5 that is placed outside reactor 102, and is connected to acoustic horn 6 that is placed inside reactor 102, by means of elastic rod or spring 110.

System 100 optionally and preferably also comprises a set of strings 106, placed under tension within reactor 102 and selected to resonantly vibrate at a predetermined frequency, responsively to the soundwaves 104 and/or 12. Strings 106 are illustrated in greater detail in FIGS. 5A-F. FIGS. 5A-C, E and F, illustrate several configurations that can be used for strings 106 according to some embodiments of the present invention, and FIG. 5D shows strings 106 when acoustically coupled to transducers 2 and 3. In the illustration of FIG. 5D, both transducers 2 and 3 are contact transducers, but it is to be understood that one or more of transducers 2 and 3 can be a non-contact transducer, as further detailed hereinabove.

The resonance frequency or frequencies of strings 106 can be set by a judicious selection of the length and tension of the strings in the set. Typically, but not necessarily, strings 106 are made of a metal, such as, but not limited to, titanium, titanium alloy and stainless steel. Alternatively, strings 106 can be made of a polymeric or compound material.

The length of strings 106 is preferably at least one wavelength of the arriving sound waves. Each of strings 106 can have a diameter of from about 30 μm to about 500 μm. Strings 106 can be weaved, tied, crossed there amongst, or be individually aligned, with gaps of from about 10 to about 1000 microns or from about 10 microns to about 800 microns between adjacent strings. A typical mesh size for the arrangement of strings 106 is from about 30 to about 120. String 106 can optionally and preferably have one or more diffraction capsules, sound wave reflectors, and/or angular deflectors to enhance the acoustic interactions of the string with the sound waves.

In embodiments in which acoustic membrane 15 is employed, acoustic membrane 15 is optionally and preferably coupled directly to set of strings 106. Alternatively, membrane 15 can be positioned within a distance from strings 106. The distance between membrane 15 and strings 106, is optionally and preferably a multiple number of wavelengths or half wavelengths of the soundwave. Preferably, the distance between membrane 15 and strings 106 does not deviate by more than half wavelength from a multiple number of wavelengths of the soundwave. Acoustic membrane 15 receives the sound wave 112 propagating in waveguide 16 and couples is to the set of strings 106. The liquid and particles flowing in the reactor typically contact both membrane 15 and strings 106 and can therefore serve as a coupling medium.

The strings in set of strings 106 are optionally and preferably arranged conically (FIGS. 5A and 5B) to receive soundwave 12 from transducer 3 at an apex of the conical arrangement. The generatrix of the conical arrangement is generally shown in FIG. 1A at 14. When reactor 102 is tapered, the tapering of reactor 102 and of set of strings 106 are preferably opposite to each other, so that soundwave 104 from transducer 3 experiences a gradually reducing volume as it propagates (e.g., downwards), increasing energy density, and soundwave 12 from transducer 2 experiences a gradually decreasing string mesh area as it propagates (e.g., upwards). The advantage of these embodiments is that with such configurations, there are colliding zones at which both soundwaves 104 and 12 are of high intensities. However, this need not necessarily be the case since the conical arrangement of strings 106 can be oriented either with the smaller cross section facing upwards (FIG. 5A) or downwards (FIG. 5B). Further, the present embodiments also contemplate a non-tapered arrangement for strings 106, for example, a generally cylindrical arrangement as exemplified in FIG. 5C. Arrangements forming other geometrical shapes are also contemplated. Representative examples of such geometrical shapes include, without limitation, flat, parabolic, elliptical, round, triangular, circular or any combinations thereof. A representative example a flat arrangement is illustrated in FIGS. 5E and 5F, where FIG. 5E shows arrangement for strings 106, and FIG. 5E shows a preferred deployment of arrangement for strings 106 in of reactor 102. Flat arrangement 106 is shown positioned at the lower half of reactor 102, but in some embodiments it can alternatively be positioned at any section of the reactor, depending on the desired insertion length of the part of transducer 3 that is within reactor 102 (e.g., the length of rod 110). The present embodiments also contemplate use of more than one arrangement of strings 106. For example, system 100 can include a combination in which one arrangement of strings is flat, and another arrangement of strings is conical or cylindrical.

In some embodiments of the present invention system 100 comprises an acoustic refracting element 11 for refracting soundwave 12 produced by transducer 3 before soundwave 12 arrives at set of strings 106. Acoustic refracting element 11 can have a round shape, e.g., in the form of a capsule. Preferably, the size of refracting element 11 is selected so as to reduce the amount of energy reflected from element 11. Typically, but not necessarily element 11 has a size of less than one wavelength of the soundwave, e.g., from about half wavelength to less than one wavelength, or about half wavelength of the soundwave. Element 11 can be made of a metal or a ceramic material.

Refracting element 11 improves the coupling of the directional axis of the arriving soundwaves with the directional layout of the strings. Element 11 is optionally and preferably attached at the top of the string set 106, or at anywhere between the arriving soundwave axis and the longitudinal direction with respect to strings in set 106.

It is appreciated that the interaction between the soundwave and the material to be processed can generate substantive heat. Thus, according to some embodiments of the present invention at least a portion of reactor 102 comprises a cooling passage 114 at a wall of reactor 102. For example, reactor 102 can be double-walled reactor in which case cooling passage 114 is between an inner wall and an outer wall of the double wall. A cooling fluid, e.g., water or a refrigerant, can be introduced into passage 114 from a cooling system (not shown) via a cooling fluid inlet 10. In various exemplary embodiments of the invention the cooling passage 114 is separated from the interior of reactor 102 so as to prevent any mixing between the cooling fluid and the material to be processed.

Also contemplated, are embodiments in which the material to be processed is thermally treated by cooling or heating prior to entering into the inlet (e.g., into port 9). Cooling is preferred when it is desired to increase the viscosity of the material to be processed, and heating is preferred when it is desired to decrease the viscosity of the material to be processed. Such thermally treatment can be executed either instead or more preferably in combination with the use flow of cooling fluid in passage 114.

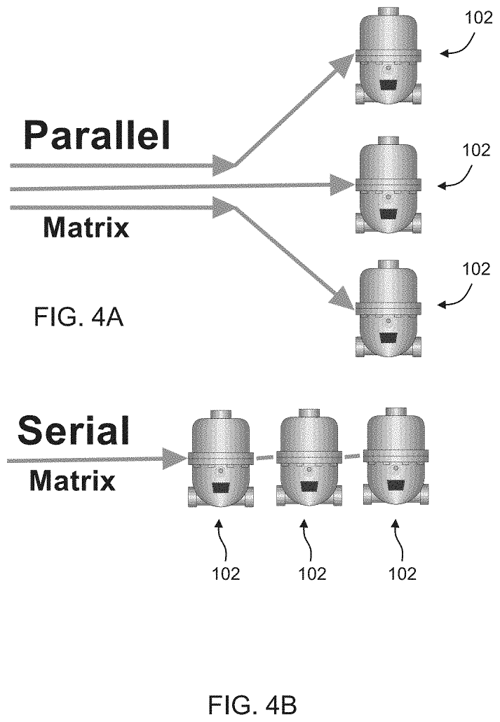

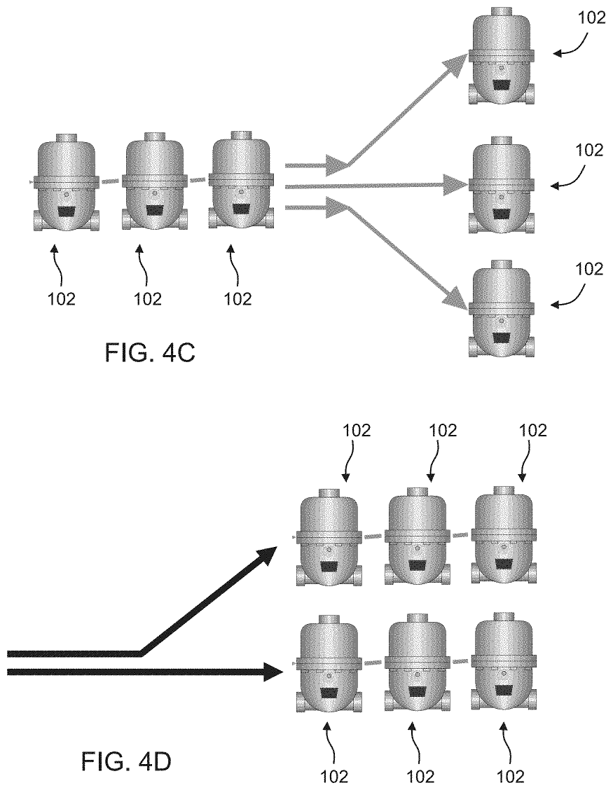

In some embodiments of the present invention reactor 102 can be connected to another reactor having the same or similar structure, as described below with reference to FIGS. 4A-D. The connection can be by a connector, shown at 19.

Connection of two or more reactors can serve for increasing the throughput, in which case each of the connectors preferably receives a separate flow of material through the respective inlet and releases a separate flow of processed material and through the respective outlet. Such a connection between two or more reactors is referred to herein as a parallel connection, and is schematically illustrated in FIG. 4A. In embodiments in which parallel connection is employed, the material in two or more of the reactors is subjected to the same condition (e.g., soundwaves with the same acoustic parameters). In some embodiments of the present invention, however, the material in two or more of the reactors is subjected to the different conditions. These embodiments are particularly useful when it is desired to simultaneously process different materials, or to simultaneously provide different process materials from the same input material.

Alternatively, the connection of two or more reactors can serve for performing a multistage processing, in which case the flow of processed material released from the outlet of one reactor is used as the input flow into the inlet of another reactor. Such a connection between two or more reactors is referred to herein as a serial connection, and is illustrated in FIG. 4B.

In embodiments in which serial connection is employed, the same batch of material is further processed by the other reactor (e.g., to further reduce the particle size, or to increase the amount of target substance that is extracted, or to increase the sterilization level). In embodiments in which serial connection is employed, the material in two or more of the reactors is optionally and preferably subjected to the different conditions (e.g., soundwaves with different acoustic parameters). For example, the intensities of the soundwaves can be different in the two reactors, so as to provide, e.g., coarse grinding in one reactor and more fine grinding in one of the subsequent reactors. Yet, in experiments performed by the inventor it was found that the use of serially connected reactors improves the efficiency of the processing operation even when the material in the serially connected reactors is subjected to the same condition. Thus, according to some embodiments of the present invention two or more reactors are connected serially wherein the material in at least two of the serially connected reactors is subjected to the same condition (e.g., soundwaves with the same acoustic parameters).

Also contemplated, are embodiments in which both serial and parallel connections of reactors are employed. For example, as illustrated in FIG. 4C, two or more reactors can be connected in a serial connection for multistage processing, wherein the output of the multistage processing is fed in parallel to two or more reactors connected in parallel. Another example is illustrated in FIG. 4D, wherein two or more reactors that are connected in a parallel connection and the output of each reactor is fed to two or more reactors connected in serial for multistage processing. Other combinations of parallel and serial connections are also contemplated.

In some embodiments of the present invention system 100 comprises a control system 116 having a circuit configured for driving the transducers 2 and 3 to produce the soundwaves at the predetermined frequency, which is preferably an acoustic frequency (e.g., from about 20 Hz to about 20 kHz). The control lines between control system 116 and transducers 2 and 3 are generally shown at 4.

Typically, but not necessarily, the circuit of control system 116 can be configured to drive transducers 2 and 3 to produce the soundwaves at the resonance frequency of set of strings 106, thereby significantly increasing the intensity of the soundwaves in the reactor. Typically, the frequency is tunable, thereby allowing the operator to vary the frequency so as to improve the efficiency of the process. For example, when system 100 is used for extraction, the frequency can be varied so as to increase the rate of change in the amount of dissolved solids content in the liquid exiting through outlet 18. The amount of dissolved solid content is known to correlate with degrees Brix (° Bx). Thus, the degrees Brix of the liquid exiting through outlet 18 can be monitored, and the frequency can be varied until an increase in the degrees Brix is observed or until a certain threshold (e.g., viscosity threshold, particle size distribution threshold, temperature threshold, color threshold, total suspended solids threshold, UVT threshold, turbidity threshold, pressure threshold, sound pressure level threshold) is achieved.

The circuit of control system 116 optionally and preferably drives both transducers 2 and 3 to produce sound waves of the same frequency. In some embodiments of the present invention circuit of control system 116 derives one of transducers 2 and 3 at a frequency that is an integer or half-integer multiplication of the frequency or wavelength of the soundwave generated by the other transducer.

Each of transducers 2 and 3 can be driven by the circuit of system 116 continuously or in pulses or any combination thereof. In various exemplary embodiments of the invention control system 116 derives transducers 2 and 3 to generate the soundwaves simultaneously, e.g., when it is desired to intentionally create collision effects between the two wave fronts such as in creating constructive interference. In some embodiments, however, it may be preferred to generate the soundwaves sequentially, e.g., when it is desired to avoid collision effect between the two wave fronts which may assist in increasing homogenization of the liquid to be processed. In some embodiments, it may be preferred to generate the soundwaves simultaneously.

In some embodiments of the present invention the circuit of control system 116 drives the transducers to operate in phase, in some embodiments of the present invention the circuit of control system 116 drives the transducers to operate out-of-phase (e.g., in opposite phases). In some embodiments, the circuit of control system 116 takes into account the delay between the time at which the soundwave is produced at the transducer and the time at which the soundwave reached the reactor 102 and is coupled into the liquid to be processed, and thus drives the transducers such that the soundwaves that propagate in reactor 102 are in phase or out-of-phase (e.g., opposite phases).

The circuit of control system 116 can produce an AC signal of any waveform for driving the transducers. Representative examples for waveforms suitable for the present embodiments include, without limitation, a sawtooth signal, a triangle wave signal, a square wave signal, a sinusoidal signal, a signal composed of a combination of wavelets, and the like. In experiments performed by the Inventors, a sawtooth signal was employed as well as other waveforms with various wave fronts.

The present inventor also contemplates embodiments in which the circuit of control system 116 operates the transducers to generate complex soundwaves having both partial soundwaves that have on-resonance and partial soundwaves that have off-resonance frequencies. Preferably, the sound intensity is higher for of the partial soundwaves that have on-resonance frequencies than for the partial soundwaves that have off-resonance frequencies. For example, the sound intensity of the partial soundwaves that have off-resonance frequencies can be from about 30% to about 70%, e.g., about 50% of the partial soundwaves that have on-resonance frequencies.

In some embodiments of the present invention the partial soundwaves that have off-resonance frequencies are modulated by AM modulation. Any modulation waveform can be used, including, without limitation, sawtooth modulation waveform, square wave modulation waveform, triangular modulation waveform, sine modulation waveform, and the like. The AM modulation typically has a period of from about 20 ms to about 40 ms. As a representative example, the AM modulation can include gradual increment of the sound intensity until the maximal level (which, is typically from about 30% to about 70% of the intensity of the partial soundwaves that have on-resonance frequencies) over a time duration of from about 15 ms to about 25 ms, e.g., about 20 ms, followed by a time period of from about 8 ms to about 16 ms over which the intensity remains at its maximal level.

The modulation can be applied by a ring modulator, a Low Frequency Oscillators, or any combinations thereof. The modulation frequency is optionally and preferably from about 18 kHz to about 22 kHz. The modulator can have a modulation impact of from about 2% to about 100%. The partial soundwaves that have off-resonance frequencies can, in some embodiments of the present invention, form a noise, such as, but not limited to, white noise or pink noise, and the like.

Control system 116 is connected to a power source 1, such as, but not limited to, an AC power source providing RMS voltage output of, e.g., 220 volts or 110 volts, at a frequency of, e.g., 50 Hz or 60 Hz. Other types of power sources (e.g., a DC power source) and other power characteristics (e.g., different voltage outputs or frequencies) are also contemplated according to some embodiments of the present invention. In various exemplary embodiments of the invention control system 116 comprise a synthesizer 7 and a computer 8. Synthesizer 7 comprises a circuit providing an electrical signal that drives the transducers 2 and 3 according to one or more tunable parameters, including, without limitation, the frequency of the driving signal, the pitch of the driving signal, the envelope, the attack time of the driving signal, the decay time of the driving signal, the sustain level of the driving signal and the release time of the driving signal.

Synthesizer 7 can be a standalone system, or can be a modular component, and maybe of any type. Examples including but not limited to analogue, digital, hybrid, signal processing synthesizer, or any combinations for purpose of forming any type of synthesis technique including but not limited to adaptive synthesis, digital synthesis, analog synthesis, physical modeling synthesis, subtractive synthesis, FM synthesis, PCM synthesis, sampling synthesis, random synthesis, or any combinations thereof.

Computer 8 optionally and preferably comprises an I/O circuit that controls to operation of synthesizer 7, and selects the values of the aforementioned one or more tunable parameters, typically in response to user input, or as part of a preset, or sequence of programming or combinations.

The circuit of synthesizer 7 can be an all-digital circuit, an all-analog circuit, or it can be a hybrid circuit having digital and analog components. The circuit of synthesizer 7 typically includes a Voltage Controlled Amplifier (VCA) for selecting the pitch of the driving signal and/or a Voltage Controlled Oscillator (VCO) for selecting the frequency of the driving signal.

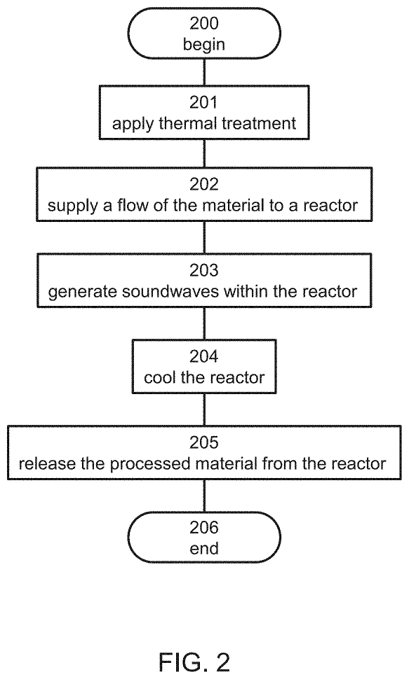

FIG. 2 is a flowchart diagram of a method suitable for processing a material according to various exemplary embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The method begins at 200 and optionally and preferably continues to 202 at which a flow of the material is supplied to a reactor having an inlet for receiving flow and an outlet for releasing processed material from reactor. For example, the material can be supplied to reactor 102 as further detailed hereinabove. In some embodiments of the present invention operation 202 is preceded by an operation 201 in which the material to be processed is cooled or heated. The method optionally and preferably continues to 203 at which soundwaves are generated to propagate within the reactor and through the material in opposite directions, and to resonantly vibrate a set of strings placed under tension within the reactor, as further detailed hereinabove. In some embodiments of the present invention one of soundwaves is coupled to the reactor by an acoustic horn placed inside reactor, and in some embodiments of the present invention one of soundwaves is coupled to the reactor by an acoustic waveguide, as further detailed hereinabove.

The soundwaves can be generated by transmitting to one or more, optionally and preferably at least two transducers, a signal having a waveform selected from the group consisting of a sawtooth waveform, a triangular waveform, a square wave waveform, a sinusoidal waveform, and a signal composed of a combination of wavelets. The transducer can be driven to operate in phase or out-of-phase (e.g., in opposite phases), or they can be driven such that soundwaves are in phase or out-of-phase (e.g., in opposite phases), as further detailed hereinabove.

Optionally, one of soundwaves is refracted before the soundwave arrives at set of strings, for example, by means of an acoustic refracting element (e.g., acoustic refracting element 11) as further detailed hereinabove. In some embodiments of the present invention the method proceeds to 204 at which the reactor is cooled, as further detailed hereinabove.

The method can continue to 205 at which the processed material is released from the reactor, as further detailed hereinabove.

In some embodiments of the present invention the direction of flow of material in the reactor is reversed (for example, by switching between a state of the reactor in which port 9 serves as the inlet and port 18 serves as the outlet, to a state of the reactor in which port 18 serves as the inlet and port 9 serves as the outlet). The reversing can be executed one or more times, based on a predetermined protocol, for example, periodically, and/or in response to a monitored soundwave property or condition of the material within the reactor.

The method ends at 206.

Following are preferred operational parameters for the system and method according to some embodiments of the present invention.

The energy density inside the reactor, for example, in proximity to the strings is from about 10 to about 5000 W/cm², or from about 10 to about 1000 W/cm², or from about 800 W/cm² to about several kW/cm².

The amplitudes of transducers may vary from about 100 microns to about 5 cm, or from about 100 micron to about 4 cm, or from about 200 microns to about 4 cm, or from about 400 microns to about 4 cm, or from about 1 mm to about 4 cm, or from about 1 cm to about 4 cm. The output wave can have pulse energy of from about 10 Joules per pulse to about 60 Joules per pulse.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

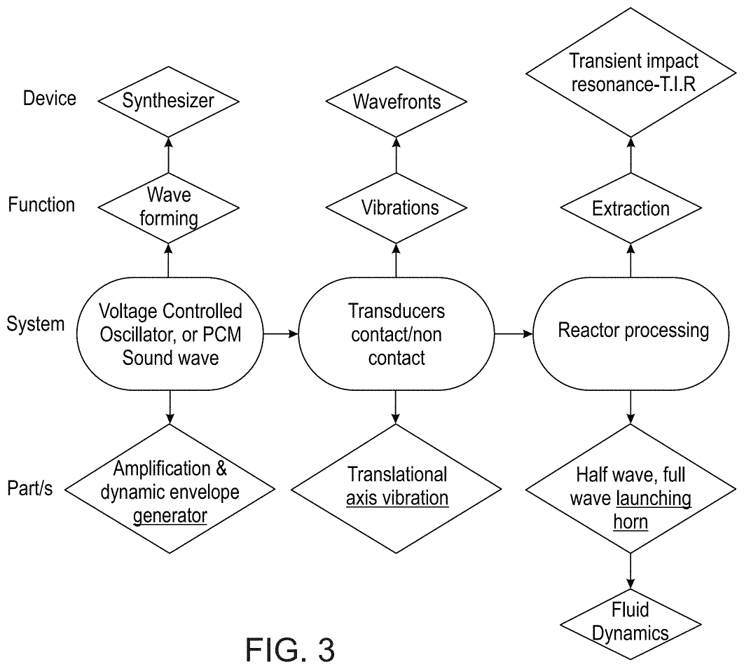

A prototype reactor according to some embodiments of the present invention was manufactured and experimentally tested. A block diagram of the experimental setup is illustrated in FIG. 3. A voltage controlled oscillator of a synthesizer formed an amplified signal which drives an external transducer. In the present Example, a piezoelectric contact transducer and a loudspeaker non-contact transducer received the drive electrical signal and responsively generated soundwaves. The piezoelectric contact transducer transmitted the soundwave to the reactor by means of an acoustic horn placed inside the reactor, and the loudspeaker non-contact transducer transmitted the soundwave to the reactor by means of an acoustic hollow air core waveguide ending with a vibrating membrane physically coupled to the reactor body which together with the medium to be processed propagate the soundwave to the conical set of strings inside the reactor. The soundwaves thus generated by both contact and non-contact transducers, have wave fronts which propagate in opposite directions within the reactor. Several acoustic horns were used. These included: quarter wave, half wave, full wave and combinations of horn types. Several acoustic membranes were used. These included: flat, bent, rounded, curved, parabolic, concentric, pointed, tilted, diverging, and any combinations thereof.

Coffee suspension was made by adding 800 grams of black roasted and ground coffee powder to a water volume of 8 (units)×900 milliliters, providing a 10% concentration coffee suspension. The suspension was mixed manually for 1 minute and poured into the preparation reservoir where it was further mixed by a motorized stirrer operating at 60 rounds per minute (RPMs). The coffee suspension was than pumped using a diaphragm type pump to two processing reactors via flexible food grade polymeric pipes. The flow rate of the pumped coffee suspension was from about 150-180 liter per hour approximately.

The coffee suspension was processed by the two reactors sequentially. Each reactor was equipped with two type of transducers a contact transducer coupled at the top end, and a non-contact transducer coupled via hollow air core acoustic waveguide to the bottom end. Each of the four transducers was driven by a synthesizer which produced a mixed combination of triangular and saw tooth wave forms. The wavelength of the acoustic waves was in the audio spectrum with a frequency of about 5300 Hz. A low frequency oscillator as well as several low, medium and high filters where applied to the signal and a dynamic envelope generator was configured to produce a sharp attack transient type sound waves in the audio spectrum by modulating voltage controlled oscillators. The synthesized signals were then amplified and set to drive the transducers.

The amplitude of the resulting sound wave produced by the transducers in the reactors was in the range from about 50 microns to about 150 microns. Average power of less than 2400 Watts was delivered to the reactors with peak 1200 watts average power delivered to each reactor. Each reactor included a conical string set and an inlet and outlet. The coffee suspension pathways created a processing loop which returned the suspension to the prep reservoir and allow simultaneous sampling from the processing loop via a dedicated sampling valve and designated piping outlet.

200 cc samples were taken from the processing loop sequentially at times: 0, 30, and 45 minutes. Samples taken were analyzed for total solids and degrees Brix the results indicated that the 10% ground coffee powder present in the suspension was extracted and both Brix and amount of solids reaffirm that the extraction process is effective. The viscosity of the suspension increased as well as its flavor impact compared with the untreated reference sample.

TABLE 1
presents the operation parameters used in the experiments

| Wavelength: | Time: 0 min | | |
|---|---|---|---|
| 5330 Hz | (reference) | Time: 30 min | Time: 45 min |
| Amplitude: | Non Active | Active | Active |
| 100 microns | | | |
| LFO: 30% | | | |
| Wave form: | Non Active | Active | Active |
| Triangular saw | | | |
| tooth | | | |
| ADSR Dynamic | Non Active | Active | Active |
| Envelope: 20% | | | |
| Coffee suspension | Not Processed | Active | Active |
| concentration: 10% | | Processing | Processing |
| Average Powers for | Transducers | 800 W ± 10% | 800 W ± 10% |
| each of the 2 | off: 0 W | | |
| reactors | | | |

The results of the experiments are summarized in Table 2, below. In Table 2, D×(10), D×(50) and D×(90) refer to particle diameters, in microns.

TABLE 2

| | | | Caffeine | percentage | percentage | percentage |
|---|---|---|---|---|---|---|
| | | total solids | (% dry | of Dx(10) | of Dx(50) | of Dx(90) |
| sample | Brix [°] | (%) | basis) | μm particles | μm particles | μm particles |
| Ref 1 | 5.9 | 11.6 | | | | |
| Sample 1 | 13.3 | 10.2 | | 0.58% | 1.54% | 7.69% |
| Ref 2 | 3.7 | 9.7 | 1.63 | | | |
| Sample 2 | 6.9 | 6.5 | 2.58 | | | |

As shown, for both samples the degrees Brix was increased and the total solid content was reduced.

Additional experiments were performed with various modulation configurations. Table 3 presents the operation parameters used in these experiments.

TABLE 3

| | |
|---|---|
| Frequency | 5350 Hz, 3530 Hz |
| Wave form | Triangular, Saw-tooth, rectangular morphing |
| | synthesized mix |
| Modulation sources | Analog synth, digital synth, VCO, VCA, VCF, |
| | HPF, LPF, LFOs, Ring, Noise sources |
| Transducer type | contact and non-contact |
| Average power | 800-1200 W |

The LFO percentage of modulation was 30%. The wave type was short pulsating attack transients with repeatable cyclic dynamic envelop. Two types of routing have been used: analog cable routing and digital using internal software.

The results of the experiments are summarized in Table 4, below.

TABLE 4

| Sample name | Brix [°] | Total Solids [%] | Caffeine [Dry] |
|---|---|---|---|
| Ref | 4 | 8.9 | 1.6 |
| Loop 1 | 4 | 4 | 2.1 |
| Loop 2 | 4.3 | 4.2 | 2.2 |
| Loop 3 | 4.3 | 4.1 | 2.1 |
| Ref | 4.2 | 10.6 | |
| Loop 1 | 8 | 10.2 | |
| Ref | 5.9 | 14.8 | |
| 10 min | 10 | 14 | |

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A system for processing a material, the system comprising:
a reactor having an inlet for receiving a flow of the material and an outlet for releasing processed material from said reactor;
a first acoustic transducer and a second acoustic transducer, acoustically coupled from two opposite ends to said reactor for producing soundwaves propagating within said reactor and through the material in opposite directions; and
a set of strings, placed under tension within said reactor and selected to resonantly vibrate at a predetermined frequency, responsively to said soundwaves.

2. The system of claim 1, wherein said set of strings are arranged conically to receive soundwaves from said first transducer at an apex of said conical arrangement.

3. The system of claim 1, wherein said set of strings are arranged to form a flat shape.

4. The system of claim 1, wherein said set of strings are arranged to form a shape selected from the group consisting of a parabolic shape, an elliptical shape, a round shape, a triangular shape, and a circular shape.

5. The system according to claim 1, wherein at least one of said first and said second transducers is an electromagnetic transducer.

6. The system according to claim 1, wherein each of said first and said second transducers is an electromagnetic transducer.

7. The system according to claim 1, wherein said first transducer is coupled to said reactor by an acoustic horn placed inside said reactor.

8. (canceled)

9. The system according to claim 1, wherein said second transducer is coupled to said reactor by an acoustic waveguide.

10-14. (canceled)

15. The system according to claim 2, further comprising an acoustic refracting element for refracting a soundwave produced by said first transducer before said soundwave arrives at said set of strings.

16. (canceled)

17. The system according to claim 1, wherein at least a portion of said reactor comprises a cooling passage at a wall of said reactor.

18. (canceled)

19. The system according to claim 1, further comprising a control system having a circuit configured for driving said transducers to produce said soundwaves at said predetermined frequency.

20-31. (canceled)

32. A system for processing a material, the system comprising:
a reactor having an inlet for receiving a flow of the material and an outlet for releasing processed material from said reactor;
an acoustic transducer for producing soundwaves propagating within said reactor and through the material; and
at least one string, placed under tension within said reactor and selected to resonantly vibrate at a predetermined frequency, responsively to said soundwave.

33. The system of claim 32, wherein said reactor is a conduit.

34. The system of claim 32, wherein said reactor is a chamber.

35. The system according to claim 32, further comprising an acoustic component selected from the group consisting of an acoustic reflector, an acoustic deflector, a refractive acoustic element, an acoustic stirrer, an acoustic lens, and acoustic concentrator, a compound concentrator, a compound parabolic concentrator, an acoustic absorber, and an acoustic waveguide.

36. The system according to claim 32, wherein said at least one string is a set of strings arranged conically to receive soundwaves from said first transducer at an apex of said conical arrangement.

37. The system according to claim 32, wherein said at least one string is a set of strings arranged to form a flat shape.

38. The system according to claim 32, wherein said at least one string is a set of strings arranged to form a shape selected from the group consisting of a parabolic shape, an elliptical shape, a round shape, a triangular shape, and a circular shape.

39. The system according to claim 32, said transducer is an electromagnetic transducer.

40. The system according to claim 32, wherein said transducer is coupled to said reactor by an acoustic horn placed inside said reactor.

41. (canceled)

42. The system according to claim 32, wherein said transducer is coupled to said reactor by an acoustic waveguide.

43-44. (canceled)

45. The system according to claim 32, further comprising an acoustic refracting element for refracting a soundwave produced by said first transducer before said soundwave arrives at said at least one string.

46. The system according to claim 32, wherein at least a portion of said reactor comprises a cooling passage at a wall of said reactor.

47. (canceled)

48. The system according to claim 32, further comprising a control system having a circuit configured for driving said transducer to produce said soundwave at said predetermined frequency.

49-50. (canceled)

51. A method of processing a material, the method comprising:
supplying a flow of the material to a reactor having an inlet for receiving said flow and an outlet for releasing processed material from said reactor; and
generating soundwaves to propagate within said reactor and through the material in opposite directions, and to resonantly vibrate a set of strings placed under tension within said reactor.

52-62. (canceled)

63. The method according to claim 51, comprising reversing a direction of said flow in said reactor.

64. The system or method according to claim 1, wherein the material is edible.

65. The system or method according to claim 1, wherein the material is a medicine.

66. The system or method according to claim 1, wherein the material is a cosmetic product.

67. The system or method according to claim 1, wherein the material comprises at least one type of material selected from the group consisting of: coffee beans, coffee extract, ground coffee beans, soy beans, soy extract, ground soy beans, coconut beans, coconut extract, ground coconut beans, olives, mashed olives, sugar, sucrose, sugar substitute, salt, aloe vera, aloe vera extract, echinacea, echinacea extract, algae, a fruit, and water-oil emulsion.
